(19) United States
(12) Patent Application Publication
(10) Pub. No.: US 2013/0128450 A1
(43) Pub. Date: May 23, 2013

(54) AIR VENT

(71) Applicants: Stuart Peter Redshaw, Nottingham (GB); Patrick Tindale, Nottingham (GB)

(72) Inventors: Stuart Peter Redshaw, Nottingham (GB); Patrick Tindale, Nottingham (GB)

(73) Assignee: 4Energy Limited, Nottingham (GB)

(21) Appl. No.: 13/698,827

(22) PCT Filed: May 18, 2011
(86) PCT No.: PCT/GB2011/000755

§ 371 Date: Feb. 4, 2013

(30) Foreign Application Priority Data
May 20, 2010 (GB) 1008374 9

(51) Int. Cl. F24F 13/14; G01F 1/34; G06F 1/20

(52) U.S. Cl. CPC F24F 13/14; G06F 1/20; G01F 1/34
USPC 361/679.46; 454/308; 454/314; 454/290; 73/861.47

(57) ABSTRACT

A removable vent (1) for an air ventilation system, the vent comprising: a frame (2) configured to allow the vent to be removably mounted within an opening; a grille (3) configured to allow the passage of air through the vent from a first face to a second opposing face; and a passive air flow diverter (4, 5) extending beyond the first face (7) of the vent and configured to redirect air flowing laterally across the first face to flow through the vent.

The invention relates to a removable vent for use in air ventilation systems, in particular although not exclusively for use with underfloor ventilation systems.

Underfloor ventilation systems are typically used in environments where floor space is required to be reconfigurable, examples being open plan offices and data centres. In such systems, an elevated false floor provides an underfloor plenum. Vents are provided at chosen locations to direct air into the environment from the plenum. Air conditioning can be applied to the air prior to entering the environment, to heat or cool the air. Vents can be located to achieve a desired air flow pattern in the room or rooms over the floor.

One example of an underfloor ventilation system is disclosed in GB861068, in which a series of grilles are provided in the floor at one end of a room, with air flow provided from an air conditioning unit below the floor of the room, providing a circulating air flow pattern within the room.

Modern underfloor ventilation systems tend to have a modular construction to allow for reconfiguration as required. This is most conveniently achieved by having an elevated floor constructed from uniformly sized tiles, with certain tiles replaced with floor vents. The location of floor vents allows the distribution of air flow to be controlled to a certain degree. Since such systems tend to have a central source of conditioned air, however, individual control of air flow through the floor vents is not generally possible, unless further assistance is provided, for example using additional fans. In other more recent examples of underfloor ventilation systems, GB2403000 discloses an air vent having a grille and a detachable fan unit for drawing air from a plenum into a room, and US 2008/0108296 discloses a fan-assisted floor ventilation diffuser including an enclosed diffuser housing with an air inlet opening and an air outlet opening. Such systems therefore allow for more control over the distribution of air flow from an underfloor plenum within a room. The use of additional fans, however, increases the complexity of the system, adding to the cost of installation.

In environments such as computer data centres, where underfloor ventilation systems are commonly used, control of air flow is particularly important because computer equipment, typically in the form of cabinets of rack mounted server stacks, needs to be maintained within an optimum temperature range. Depending on the anticipated load, different cabinets will require different levels of air flow to achieve an optimum degree of cooling. If the air flow is insufficient for an individual cabinet, a hot spot may arise and, if left unattended, may result in premature failure of components within the cabinet or equipment automatically shutting down to prevent overheating.

To overcome the problem of overheating, additional air flow could be provided by, for example, increasing the overall air flow through the underfloor ventilation system. This would, however, require an increased energy usage, which would be wasteful if only certain areas are at risk of overheating. An alternative solution, as envisaged by the documents mentioned above, is to install additional fans to vents where required. This would however increase the cost and complexity of the system, particularly if such additional fans require to be powered and monitored during use. Additional fans also add to the overall energy usage of the system.

It is an object of the invention to address one of more of the above mentioned problems.

The listing or discussion of an apparently prior-published document in this disclosure should not necessarily be taken as an acknowledgement that the document is part of the state of the art or is common general knowledge.

In accordance with a first aspect of the invention there is provided a removable vent for an air ventilation system, the vent comprising:
a frame configured to allow the vent to be removably mounted within an opening;
a grille configured to allow the passage of air through the vent from a first face to an opposing second face; and
a passive air flow diverter extending beyond the first face of the vent and configured to redirect air flowing laterally across the first face to flow through the vent.

An advantage of the invention is that the air flow diverter allows the vent to be used in locations where an additional degree of air flow is required relative to other vents that do not comprise such a diverter. The air flow diverter may be fixed in position or adjustable. The additional air flow is achieved by diverting air that is flowing laterally across the first face of the grille, thereby using the dynamic pressure in the direction of air flow through an underfloor plenum, in addition to the static pressure of the air within the plenum. With the air flow diverter being passive, i.e. not providing any further air flow itself by means of fans or other means to augment air flow through the vent, no additional electrical connections are required for the diverter to work, which allows the vent to be easily and quickly fitted and re-fitted as required. The air flow diverter also requires no additional power to operate.

The vent is primarily intended for use as a floor vent as part of an underfloor air ventilation system, although could also be used as a ceiling vent. When used as a floor vent, the first and second faces may be termed lower and upper faces. When used as a ceiling vent, these terms would be inverted.

The air flow diverter itself may comprise various forms. In preferred embodiments, the diverter comprises a scoop extending laterally across a portion of the first face of the vent.

The scoop, which may have a curved sectional shape, allows for laterally flowing air to be diverted while minimising turbulence in the air flow beneath the vent, thereby improving the directional effect of the diverter. The scoop may alternatively have an aerofoil or a blade shape and need not be curved,

The air flow diverter optionally comprises a first diverter extending across an edge of the first face and a second diverter extending across a mid-portion of the first face. Adding a further diverter increases the amount of air diverted to flow upwards through the vent, which is advantageous for larger sized vents. Further diverters may be added depending on the overall size of the vent.

Where there is a first and second diverter, the first diverter optionally extends beyond the first face of the vent further than the second diverter. This has the advantage of providing a more uniform flow of redirected air through the vent, since the first diverter will redirect a portion of air flowing beneath the vent that is not captured by the second diverter. For similar reasons, in certain embodiments the first diverter has a greater width than the second diverter.

The air flow diverter is optionally rotatably mounted to the vent to allow the diverter to rotate to face a direction of air flow across the first face. The diverter may be configured to be freely rotatable to allow it to respond to a change in the direction of air flow beneath the vent, for example in response to the ventilation system being reconfigured. The diverter rotational direction may optionally be selectable manually by means of an adjuster provided on the second face of the vent. Manual adjustment has the advantage of ensuring that the air flow redirection is set during fitting of the vent before the system is running, and can be re-adjusted as required if the system is reconfigured.

In accordance with a second aspect of the invention there is provided a method of configuring an air ventilation system, comprising:
providing a removable air vent according to the first aspect of the invention;
mounting the vent within an opening in the floor or ceiling of the air ventilation system; and
operating the air ventilation system.

The air ventilation system may be an underfloor ventilation system. The removable vent may be mounted for use as a floor vent or a ceiling vent.

The various optional configurations of the removable air vent according to the first aspect of the invention may also be applied to the method of configuring the air ventilation system of the second aspect of the invention.

The method of configuring the air ventilation system may further comprise adjusting the rotational orientation of the diverter to face a direction of lateral air flow across the first face of the vent.

In accordance with a third aspect of the invention there is provided an air flow meter comprising a cylindrical tube portion having a perforated first end and a transparent opposing second end and containing an indicator moveable along a longitudinal axis of the tube portion such that a differential air pressure along the tube portion causes the indicator to be forced against the transparent second end.

An advantage of an air flow meter according the invention is that of providing a simple read-out of the presence or absence of an air pressure differential across the meter, as judged by the position of the indicator within the cylindrical portion, viewed through the transparent portion. The air flow meter is particularly advantageous as part of a floor vent for an underfloor ventilation system, although may be used in other applications where a simple readout of air flow is required.

Incorporating the air flow meter into a floor vent has the advantage that an indication of air flow through the vent can be viewed without the need for measuring equipment, and an assessment can therefore be made much more quickly across an installation such as a data centre where many such vents will be used, for example across a large floor area.

The indicator and an inner wall surface of the tube portion are preferably of contrasting appearance, to enable an indication of air flow through the vent to be easily viewed.

The removable vent comprising the air flow meter may comprise a passive air flow diverter such as that of the first aspect of the invention.

In use, the air flow meter is positioned with the cylindrical tube portion aligned vertically with the transparent second end uppermost, such that differential air pressure along the tube causes the indicator to rise and be held against the transparent end. The indicator and an inner wall surface of the tube portion are preferably of contrasting appearance, to enable an indication of air flow through the vent to be easily viewed. In preferred embodiments, the upper face of the indicator has a contrasting colour to the inner wall of the tube portion.

The invention will now be described by way of example, and with reference to the enclosed drawings in which:

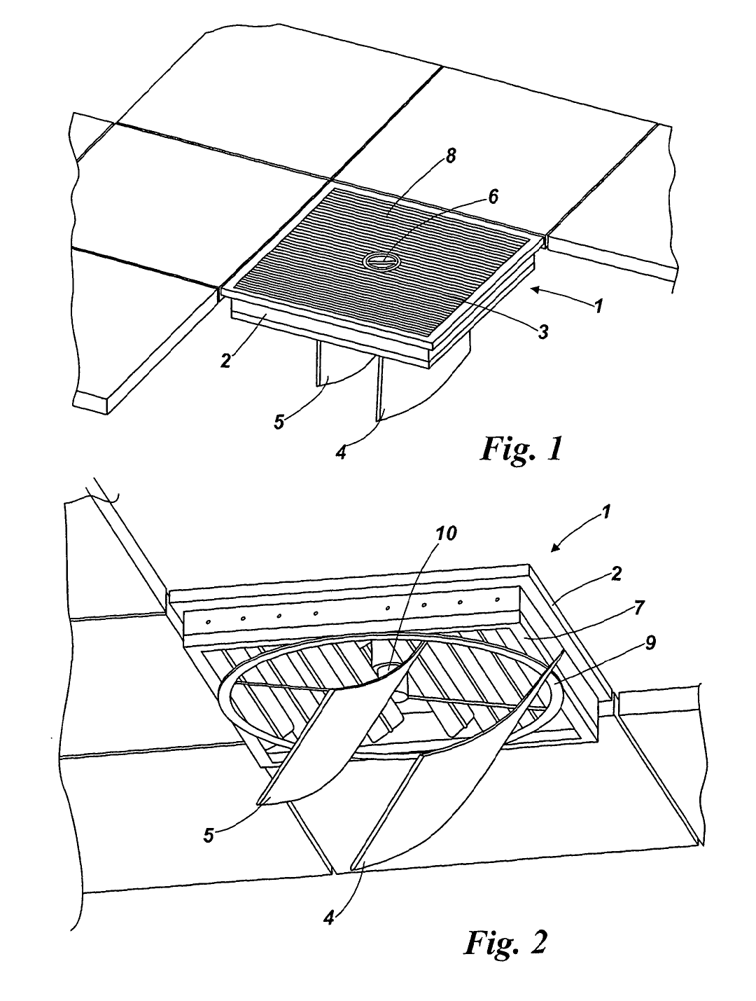

FIG. 1 is a perspective drawing of a portion of an underfloor ventilation system having a floor vent according to the invention;

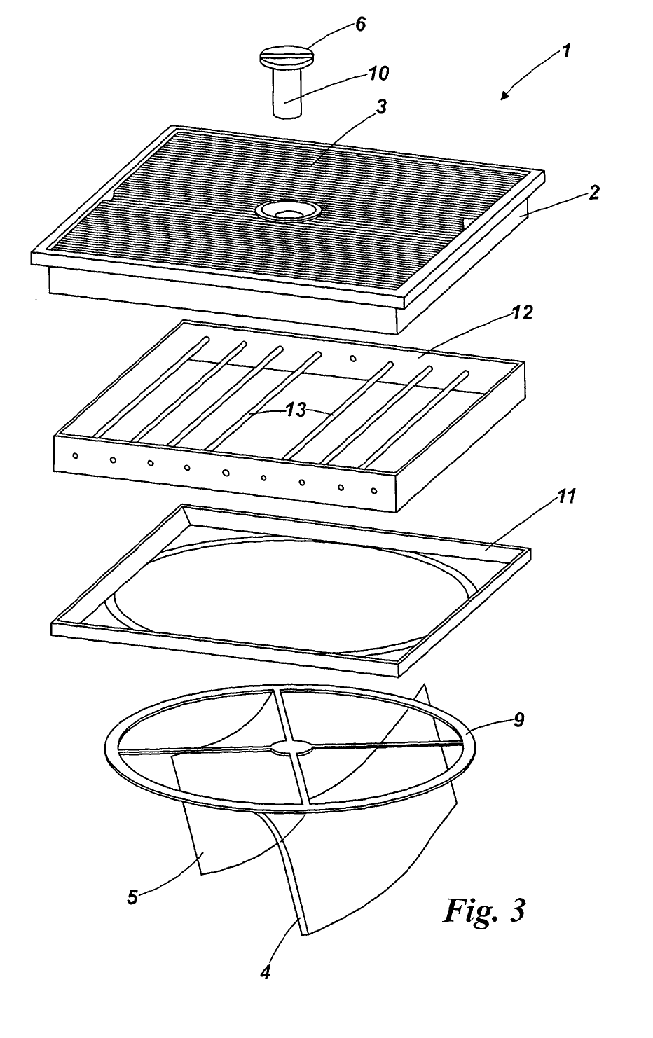

FIG. 2 is a further perspective drawing of the underfloor ventilation system of FIG. 1, showing the underside of the floor vent;

FIG. 3 is an exploded perspective drawing of a floor vent according to an embodiment of the invention;

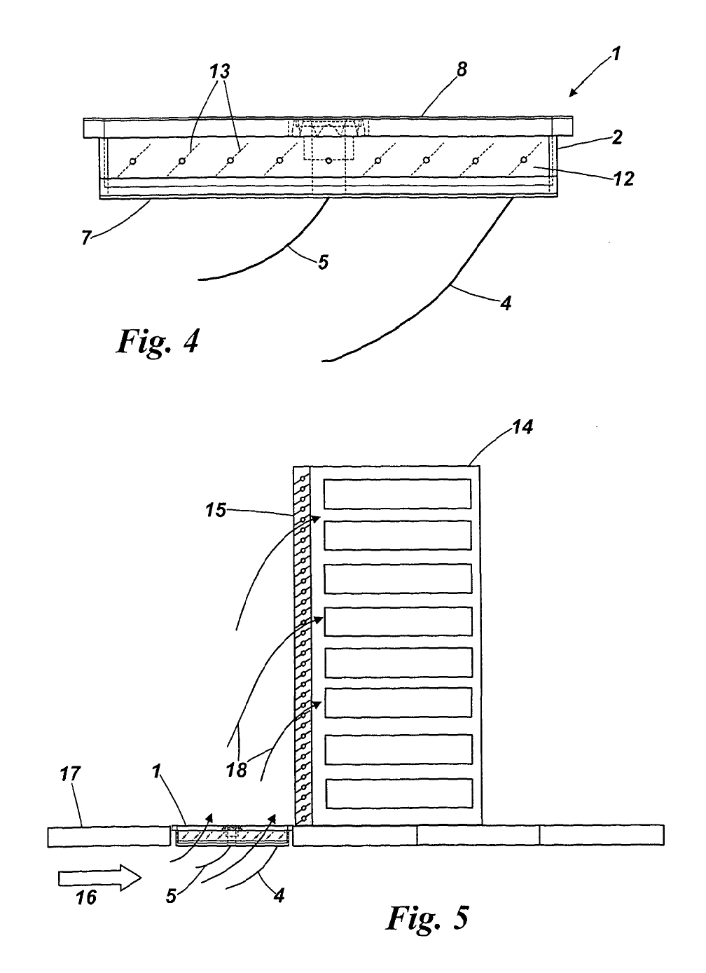

FIG. 4 is a side elevation drawing of a floor vent according to the invention;

FIG. 5 is a sectional side elevation drawing of a floor vent installed adjacent an equipment cabinet;

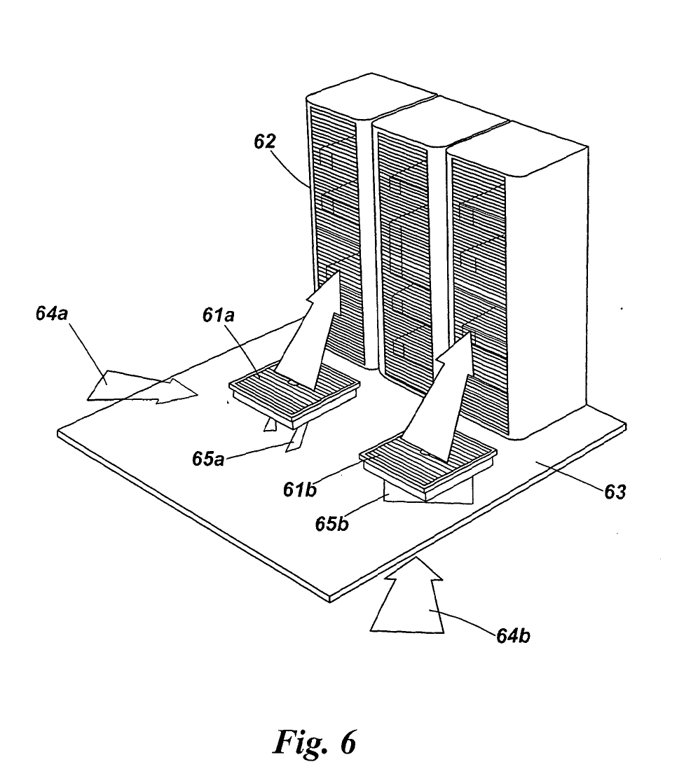

FIG. 6 is a perspective view of a row of equipment racks being supplied cooling air from two floor vents;

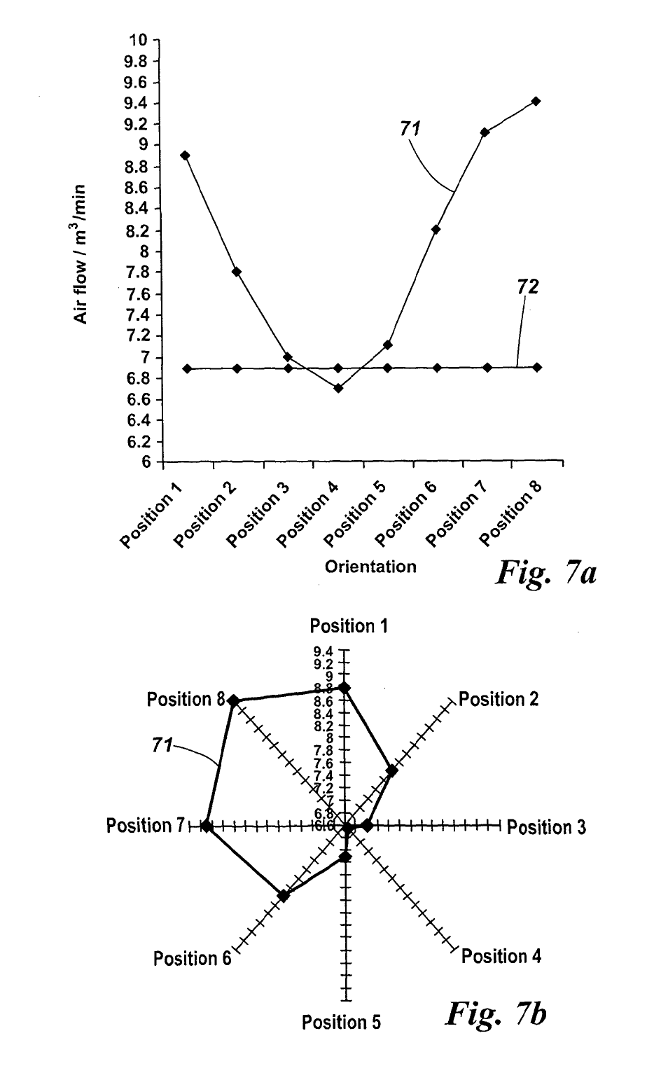

FIGS. 7a and 7b are plots of comparative measurements of air flow through a floor vent as a function of orientation;

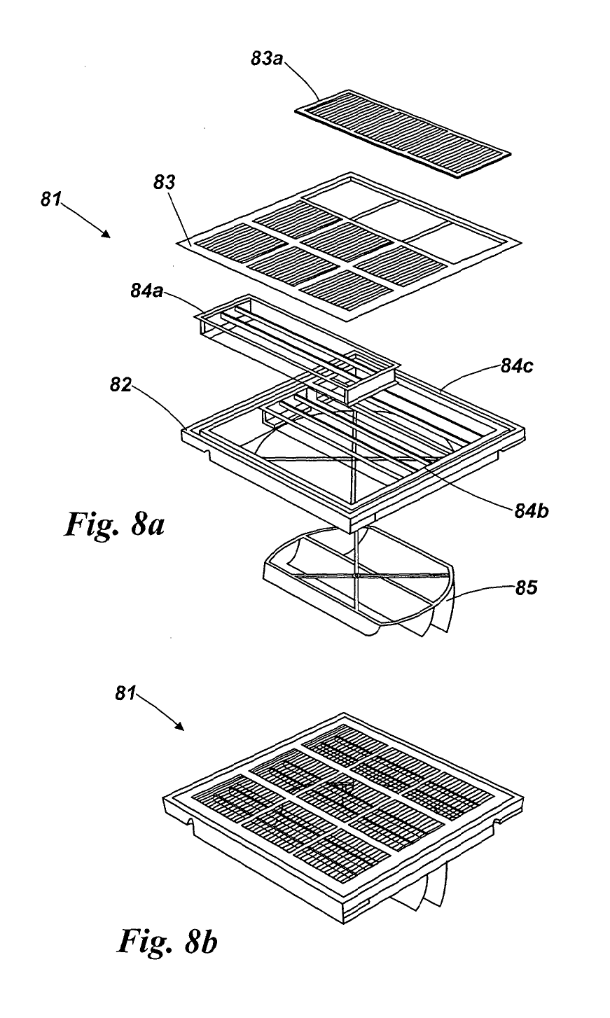

FIG. 8a is an exploded perspective view of a floor vent according to an alternative exemplary embodiment;

FIG. 8b is a perspective view of the floor vent of FIG. 8a in an assembled state;

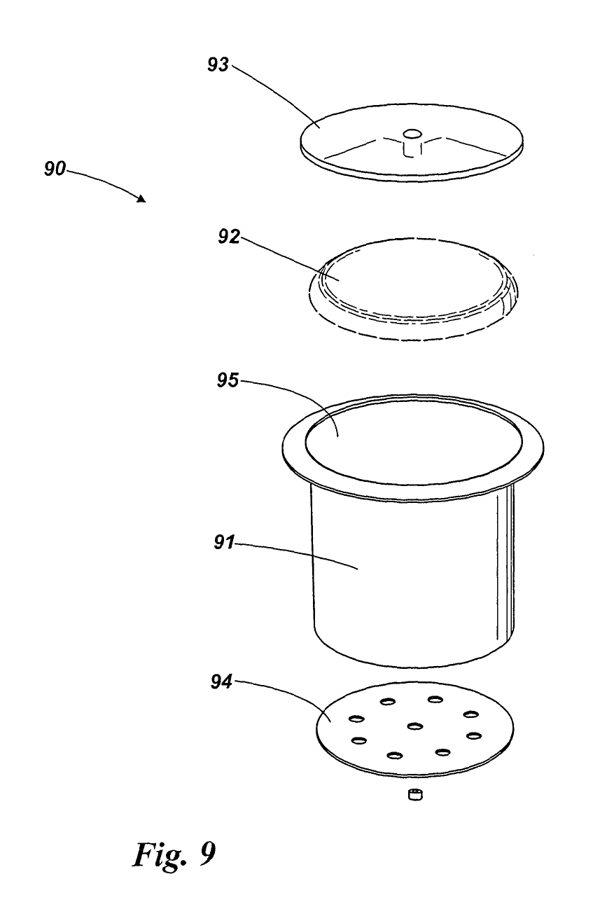

FIG. 9 is an exploded perspective view of an air flow indicator for use with a floor vent;

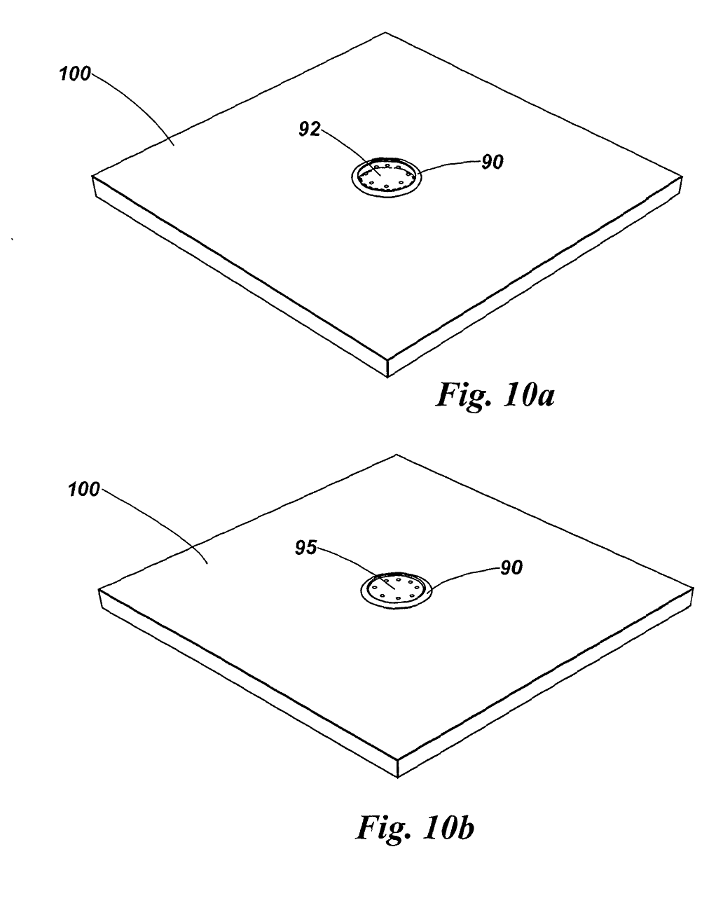

FIG. 10a is a perspective view of a portion of a floor vent comprising an air flow indicator in a position indicating no air flow;

FIG. 10b is a perspective view of a portion of a floor vent comprising and air flow indicator in a position indicating air flow;

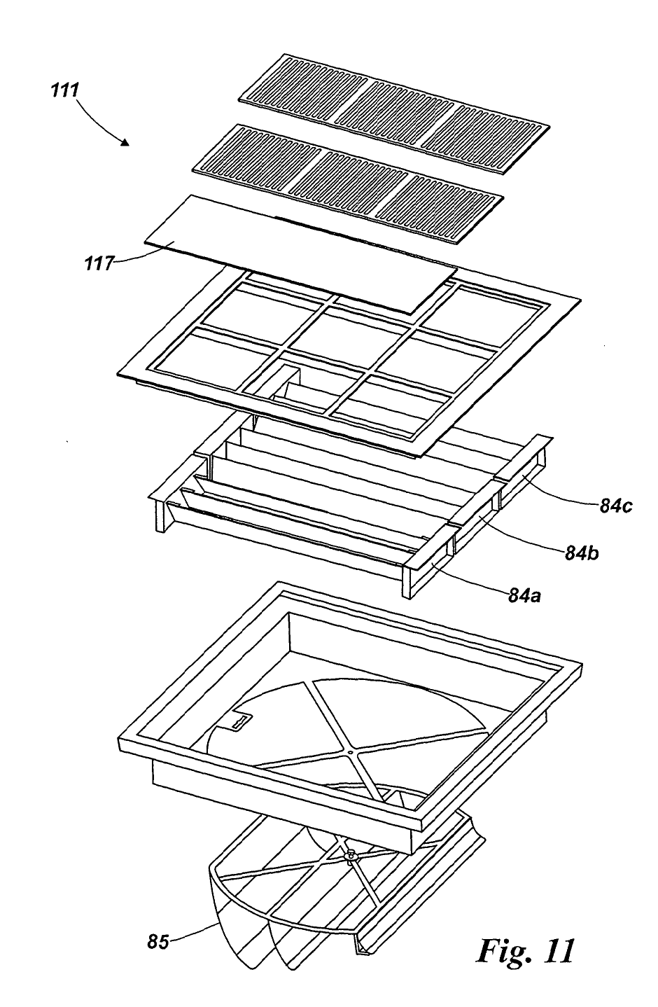

FIG. 11 is a further exploded perspective view of a floor vent according to an alternative exemplary embodiment;

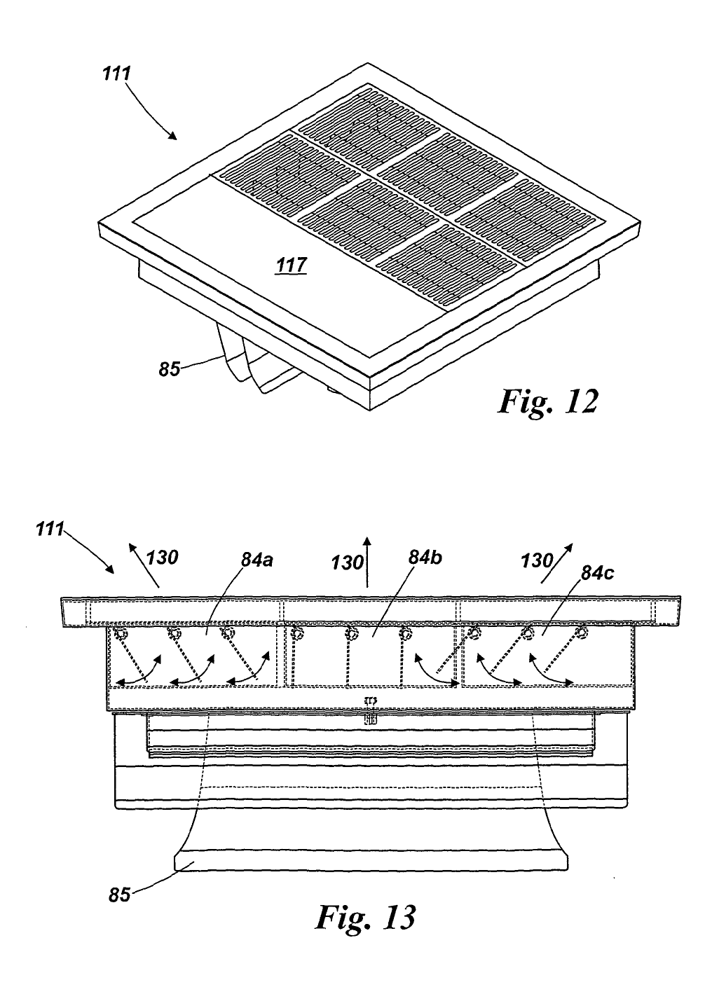

FIG. 12 is a perspective view of the floor vent of FIG. 11 in an assembled state;

FIG. 13 is a side elevation view of the floor vent of FIG. 12; and

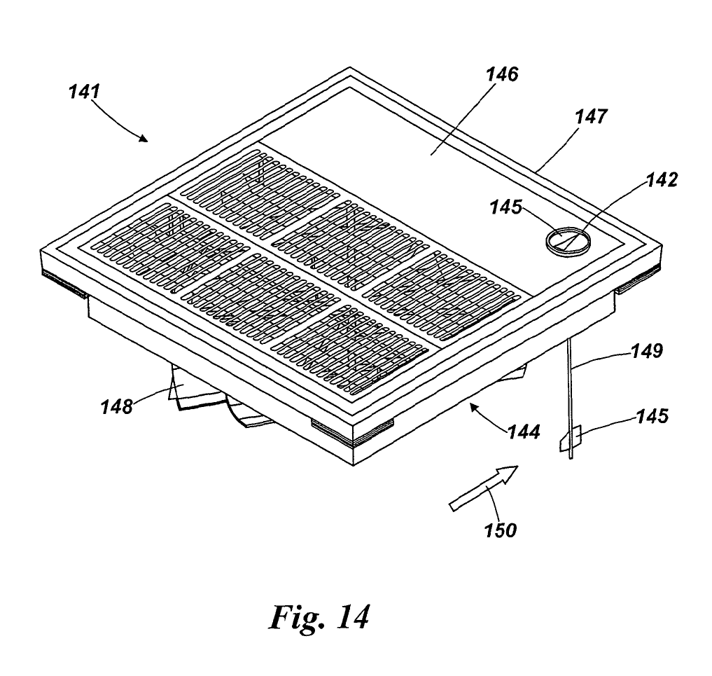

FIG. 14 is a perspective view of an embodiment of an air vent comprising an air flow direction indicator.

FIGS. 1 and 2 are perspective views of a portion of an underfloor ventilation system comprising an array of floor tiles, in which one tile is in the form of a floor vent 1. The floor vent 1 comprises a frame 2 configured to allow the vent 1 to be removably mounted within an opening in the floor. The frame will typically be rectangular or square in shape and the same size as the surrounding tiles, although larger vents covering more than one tile area may be envisaged. The vent 1 comprises a grille 3, which has sufficient strength for the tile to be walked over and allows for the passage of air through the vent 1.

The vent 1 shown in FIGS. 1 and 2 comprises an air flow diverter in the form of first and second scoop-shaped diverters 4, 5, which are configured to redirect air flowing laterally across a first (or lower) face 7 of the vent to flow through the vent 1. The diverters 4, 5 thereby increase the supply of air through the vent 1 relative to a similar vent having no such diverters. Air flow can therefore be optimised through the use of such floor vents to increase the flow of air where required. This is particularly advantageous in data centre applications, as the increased air flow can be applied to localised areas such as a server that requires an increased amount of cooling, without needing to increase the overall air flow within the system or the overall degree of cooling.

As shown in FIG. 2, which shows the underside of the floor vent 1, the diverters 4, 5 are rotatably mounted to the vent. The diverters 4, 5 are attached to a frame 9 that is rotatably mounted on the first face 7 of the vent 1 on a spindle 10. The frame 9 may be freely rotatable about the spindle 10, allowing a change in direction of air flow under the vent to cause the diverters 4, 5 to rotate. The diverters 4, 5 will then tend to always face the direction of air flow under the floor, ensuring that air flow through the vent 1 is maximised. The frame 9 may be rotatable by means of an adjuster 6 (FIG. 1) accessible from the upper face 8 of the vent. The orientation of the diverters 4, 5 may be chosen when installing the vent by rotating the adjuster 6. The adjuster 6 may comprise a friction fitting so that changes in air flow direction do not cause the diverters 4, 5 to change direction, or may comprises a locking screw or other appropriate fixing means configured to prevent rotation of the diverter once fixed in position. The adjuster 6 may comprise an indicator that shows how the diverter is oriented, as this may otherwise be difficult to see without removing the floor vent 1.

FIG. 3 is an exploded perspective view of the vent 1 of FIGS. 1 and 2, illustrating more clearly the various components of the vent 1. The diverters 4, 5 are mounted on the rotatable frame 9, which rotates relative to a lower portion 11 of the frame 2. The rotatable frame 9 and the lower portion of the frame each comprise a circular track that functions to keep the diverters 4, 5 level with respect to the frame 2 regardless of the orientation.

The vent 1 also comprises a louvre assembly 12, comprising a plurality of rotatably adjustable vanes 13 extending across the width of the vent 1. These vanes allow the air flow through the vent 1 to be further controlled, both in terms of direction and quantity. If a server stack is to be positioned to one side of the vent 1, the vanes 13 of the louvre assembly 12 can be positioned to direct the air flow towards the server, rather than vertically upwards through the vent. The air flow towards the stack is thereby further increased.

FIG. 4 shows a side elevation view of the vent 1, illustrating a preferred curved shape of the diverters 4, 5, the first diverter 4 extending beyond the second diverter 5 so that air is drawn through the vent more uniformly. The rotatably adjustable vanes 13 of the louvre assembly 12 are shown aligned so that air flow is preferentially directed towards one side of the vent, for example to provide an increased amount of cooling air to a cabinet positioned adjacent the vent.

FIG. 5 is a side elevation cross-sectional view of a part of a data centre having an underfloor ventilation system according to the invention, in which a floor vent 1 of the type described herein is positioned adjacent a cabinet 14 containing computer equipment. The cabinet 14 comprises a louvered panel 15 on a vertical face thereof for directing air from the floor vent 1 into the cabinet 14. Lateral air flow 16 below the floor 17 is preferentially directed through the floor vent by the diverters 4, 5. The louvre assembly in the vent 1 further directs the air flow, indicated by arrows 18, towards the cabinet 14, and the further louvre assembly 15 attached to the cabinet 14 preferentially directs this air into the cabinet 14.

When the rotatable diverter is manually adjustable, rather than being freely rotating in response to a changing direction of air flow, it can in some circumstances be useful to reduce rather than increase the amount of air flowing through the vent. This can be achieved by turning the diverter away from the direction of air flow in the underfloor plenum, so that the air flow minimised when the diverter is rotated 180 degrees away from the orientation where maximised air flow is obtained.

Whether the rotatable diverter is manually adjustable or freely rotatable, the direction of air flow beneath the vent can be taken into account, as shown schematically in FIG. 6. In this drawing, two vents 61a, 61b are located adjacent a row of electronic equipment stacks 62 that need to be supplied with cooling air flow. Air flow under the floor 63 is, however, supplied from two different directions, indicated by arrows 64a, 64b. The rotatable diverters 65a, 65b of each vent 61a, 61b can be oriented such that a maximum amount of air flow is directed from each direction through the vents and towards the equipment stacks 62.

FIGS. 7a and 7b show plots of test results from an exemplary floor vent having a rotatable diverter, in which air flow measurements through the vent were taken at various orientations of the diverter. The eight different positions of the rotatable diverter correspond to the diverter oriented at 45° intervals. FIG. 7a shows a comparison between air flow 71 through the exemplary floor vent and air flow 72 through a standard floor vent (i.e. without a diverter and of comparable size). In each case the louvres in the vent were maintained at the same vertical orientation. While air flow through the standard floor vent is constant at around 6.9 m³/min, air flow through the exemplary floor vent can be adjusted between around 6.6 m³/min to around 9.4 m³/min, depending on the orientation of the rotatable diverter relative to the direction of air flow under the vent. FIG. 7b shows the same results in the form of a polar plot, indicating the directionality of air flow using the rotatable diverter.

A further embodiment of a floor vent 81 is illustrated in FIG. 8, FIG. 8a showing the vent 81 in exploded view and FIG. 8b the vent 81 as assembled. As with the other embodiment described above, the vent 81 comprises a frame 82 configured to allow the vent 81 to be removably mounted within an opening in a floor, a grille 83 configured to allow passage of air through the vent, and a passive air flow diverter 85 extending beyond a first face 86 of the vent 81 and configured to redirect air flowing laterally across the first face 86 to flow through the vent 81. As with other embodiments, the diverter 85 may be rotatable relative to the frame 82 to allow for adjustment according to the direction of air flow below the vent 81.

In the embodiment of FIG. 8, the grille 83 is configured such that a portion of the grille 83a is removable, for example to allow for replacement with a blanking plate so that air flow can be restricted or optional components fitted to the vent such as an air flow meter, described in further detail below. The vent 81 also comprises a number of removable louvre units 84a, 84b, 84c, which may be removed or reoriented according to how the vent 81 is to be configured. For example, the orientation of the louvres may be fixed and a choice of direction of air flow made depending on which way round the louvre units 84a-c are oriented. Alternatively, one or more of the louvre units may be omitted if a blanking plate is used. In the embodiment shown, if the grille portion 83a is removed and replaced with a blanking plate, louvre unit 84c would not be required and can be omitted.

As it may not be possible to determine whether air flow is being maximised when rotating the diverter manually, for example if the exact direction of air flow under the floor is not known, it can be advantageous for the floor vent to include an air flow meter for indicating the flow rate of air through the vent. An air flow meter may take various forms, such as a ball within a pipe where the height of the ball indicates the air flow, or a rotatable element having an indicator or air flow. The indicator may be an electronic readout, for example in the form of an anemometer, or may more simply be a pattern that provides an indication when the element is rotating. Usually only an indication of maximum or minimum air flow will be required, so a calibrated readout would not typically be required.

An exploded view of an exemplary embodiment of an air flow meter 90 is illustrated in FIG. 9. The air flow meter 90 comprises a cylindrical tube portion 91 within which is contained an indicator 92 that is moveable along a longitudinal axis 93 of the cylindrical tube portion 91. A perforated end portion 94 is provided at one end of the tube portion 91 to allow air to flow into the tube portion and cause the indicator 92 to move within the tube portion 91. A transparent window 93 is provided at an opposing end of the tube portion 91 to allow the position of the indicator 92 within the tube portion to be viewed. The window 93 and perforated end portion 94 together keep the indicator contained within the tube portion 91. Perforations may alternatively be provided in the wall of the tube portion 91 towards the lower end. Air exit passageways are also provided at the upper end of the air flow meter 90, for example around the upper edge of the tube portion 91 or within the window 93 itself.

The indicator 92 and an inner wall surface 95 of the tube portion 91 are preferably of contrasting appearance, for example by being coloured differently. The indicator may, for example, be coloured green while the inner wall surface of the tube portion 91 is coloured red. Other contrasting colours or patterns may alternatively be selected. By selecting a contrasting appearance for the indicator 92 as compared with the tube portion inner wall surface 95, it is possible to easily view through the window 93 whether there is sufficient air pressure provided at the perforated end portion 94 of the meter 90. An advantage of this arrangement is that air flow through a floor vent within which the meter 90 is installed can be checked without the need for measurements, and any vents having insufficient air flow can be easily identified.

FIGS. 10a and 10b illustrate a portion 100 of a floor vent in which the air flow meter 90 of FIG. 9 is installed. The portion 100 may for example be part of a grille forming part of a vent, such as the vent 81 described above. The air flow meter may be incorporated into the grille as part of a blanking plate portion of the grille or into a part of the grille that allows air passage. The meter 90 is preferably incorporated into the grille such that the window 93 of the meter is visible on an upper face of the grille. When there is sufficient pressure to raise the indicator 92, the indicator 92 becomes visible as it is forced against the inner surface of the window 93, as shown in FIG. 10a. When there is insufficient pressure to raise the indicator 92, the inner wall surface 95 of the tube portion 91 becomes visible instead, as the indicator 92 will fall to the inner surface of the perforated end portion 94, as shown in FIG. 10b. The air flow meter can therefore be used as part of a floor vent according to the embodiments described herein to provide a ready indication of whether the vent has a sufficient amount of air flowing through it. The air flow meter may alternatively be provided as part of a conventional floor vent.

FIG. 11 is a further exploded view of an air vent 111 of a similar construction to the vent 81 of FIG. 8. The vent 111 comprises a blanking plate 117 over one of the three removable louvre units 84a-c, which acts to reduce the total amount of air flow through the vent 111. The vent 111 in an assembled form is illustrated further in FIGS. 12 and 13. FIG. 13 illustrates the removable louvre units 84a-c configured in different orientations to illustrate the way in which the direction of air flow through the vent 111 can be adjusted, indicated by arrows 130. Generally the louvre units will be adjusted so that the air flow is adjusted to be directed in a common direction, through in some circumstances it may be advantageous to have air flow being directed in different directions, for example to create a more diffuse air flow pattern within the ventilated room.

In general, a vent according to embodiments of the invention does not necessarily need to be in the form of a whole floor tile, but can be a portion of a tile or may be of a size and shape equivalent to multiple tiles.

The vent may also comprise other features attached on the underside, if configured as a floor vent. One example is a planar element, which may be in the form of a plate, board or curtain extending from the underside of the vent. In use, the planar element will extend vertically downwards from an edge of the vent, and be preferably located along an edge that is behind a trailing edge of the air diverter when the diverter is in a position for maximising air flow. The planar element will act to further increase the dynamic pressure in the air passing under the vent to which it is attached, and can be used to preferentially redirect air to other parts of the underfloor plenum. Such elements may for example be used to separate the plenum into two or more separate zones. Another example of a feature than may be attached on the underside of the vent is a cable support element, for example in the form of one or more hooks or conduits. Using such an element has the advantage of reducing the effect any cables running through the underfloor plenum have on the air flow through the plenum.

For embodiments where the air flow diverter is manually rotatably adjustable, adjustment of the air flow diverter can be made through the use of a specially shaped tool or only after unlocking the adjuster, so that unauthorised adjustment is prevented.

The vent may comprises one or more other sensors relevant to underfloor ventilation systems, for example temperature or humidity. The vent may comprise safety features such as a smoke detector.

FIG. 14 illustrates a further alternative embodiment, in which an air vent 141 comprises an air flow direction indicator 142. The air flow direction indicator 142 comprises a vane 143 at an end of a rod 149 that extends beyond the first face 144 of the vent 141 and a direction indicator 145 mounted on the second face 146 of the vent 141. Air flowing laterally across the first face 144 of the vent 141 causes the vane 145 to be oriented in the direction of air flow (indicated by arrow 150), which causes the direction indicator 145 to point in the direction of air flow. The direction indicator 145, rod 149 and vane 145 are rotatably mounted together to allow the vane to rotate with the direction of air flow. The air flow direction indicator 142 is preferably mounted towards a corner of the frame 147 of the vent 141 so that air flow across the vane 145 is less affected by the presence of the rotatable air diverter 148. In use, the air flow diverter can be adjusted according to the measured direction of air flow across the first face of the vent 141, for example by aligning the direction of the diverter 148 with the direction of air flow 150 to maximise air flow through the vent 141.

Other embodiments are also within the scope of the invention, as defined by the appended claims.

1. A removable vent for an air ventilation system, the removable vent comprising:
a frame configured to allow the vent to be removably mounted within an opening;
a grille configured to allow the passage of air through the vent from a first face to an opposing second face; and
a passive air flow diverter extending beyond the first face of the vent and configured to redirect air flowing laterally across the first face to flow through the vent.

2. The vent of claim 1 wherein the air flow diverter comprises a scoop extending laterally across a portion of the first face of the vent.

3. The vent of claim 2 wherein the scoop has a curved sectional shape.

4. The vent of claim 1 wherein the air flow diverter comprises a first diverter extending across an edge of the grille and a second diverter extending across a mid-portion of the vent.

5. The vent of claim 4 wherein the first diverter extends beyond the first face of the vent further than the second diverter.

6. The vent of claim 4 wherein the first diverter has a greater width than the second diverter.

7. The vent of claim 1 wherein the air flow diverter is rotatably mounted to the vent to allow the diverter to rotate to face a direction of air flow across the first face.

8. The vent of claim 7 wherein a rotational position of the diverter is selectable by means of an adjuster provided on an upper face of the vent.

9. The vent according to claim 1 comprising an adjustable louver assembly for controlling airflow through the vent.

10. An underfloor ventilation system comprising the removable vent of claim 1, wherein the vent is mounted within an opening in a floor of the ventilation system over an underfloor plenum.

11. A data centre comprising the underfloor ventilation system of claim 10, the data centre comprising a cabinet containing electronic equipment positioned adjacent the removable vent, the cabinet comprising a louvered panel on a vertical face thereof for directing air from the vent into the cabinet.

12. A method of configuring an air ventilation system, comprising:
providing a removable vent according to claim 1;
mounting the vent within an opening in the floor or ceiling of the air ventilation system; and
operating the air ventilation system.

13. An air flow meter comprising a cylindrical tube portion having a perforated first end and a transparent opposing second end, the air flow meter comprising an indicator within the cylindrical tube portion, the indicator being moveable along a longitudinal axis of the tube portion such that a differential air pressure along the tube portion causes the indicator to be forced against the transparent second end.

14. The air flow meter of claim 13 wherein the indicator and an inner wall surface of the tube portion are of contrasting appearance.

15. A removable vent for an underfloor ventilation system, the vent comprising:
a frame configured to allow the vent to be removably mounted within an opening in a floor;
a grille configured to allow the passage of air through the vent, the grille incorporating an air flow meter according to claim 13.

16. The removable vent of claim 15 comprising a passive air flow diverter extending beyond a first face of the vent and configured to redirect air flowing laterally across the first face to flow through the vent.

17. (canceled)

18. (canceled)
